(19) United States
(12) Patent Application Publication
(10) Pub. No.: US 2013/0244149 A1
(43) Pub. Date: Sep. 19, 2013

(54) CHARGED PIGMENT PARTICLES FOR ELECTROPHORETIC DISPLAY

(71) Applicants: Ming WANG, Fremont, CA (US); Peter Laxton, Alameda, CA (US); Hui Du, Milpitas, CA (US)

(72) Inventors: Ming WANG, Fremont, CA (US); Peter Laxton, Alameda, CA (US); Hui Du, Milpitas, CA (US)

(21) Appl. No.: 13/420,426

(22) Filed: Mar. 14, 2012

(51) Int. Cl. G03G 17/00

(52) U.S. Cl. 430/37

(57) ABSTRACT

The present invention is directed to a charged pigment particles useful for the electrophoretic fluid. The present invention describes how the charge property of the charged pigment particle may be controlled. By adjusting the charge property of the charged pigment particles to a suitable level for an electrophoretic display system, a faster switching speed, a higher contrast ratio and better image bistability may be achieved.

### FIELD OF THE INVENTION

The present invention is directed to charged pigment particles, an electrophoretic display fluid containing such charged pigment particles, and an electrophoretic display utilizing the electrophoretic fluid, and methods for their preparation.

### BACKGROUND OF THE INVENTION

An electrophoretic display (EPD) is a non-emissive device based on the electrophoresis phenomenon influencing charged pigment particles dispersed in a dielectric solvent. An EPD typically comprises a pair of spaced-apart plate-like electrodes. At least one of the electrode plates, typically on the viewing side, is transparent. An electrophoretic fluid composed of a dielectric solvent with charged pigment particles dispersed therein is enclosed between the two electrode plates.

An electrophoretic fluid may have one type of charged pigment particles dispersed in a solvent or solvent mixture of a contrasting color. In this case, when a voltage difference is imposed between the two electrode plates, the pigment particles migrate by attraction to the plate of polarity opposite that of the pigment particles. Thus, the color showing at the transparent plate can be either the color of the solvent or the color of the pigment particles. Reversal of plate polarity will cause the particles to migrate back to the opposite plate, thereby reversing the color.

Alternatively, an electrophoretic fluid may have two types of pigment particles of contrasting colors and carrying opposite charges and the two types of pigment particles are dispersed in a clear solvent or solvent mixture. In this case, when a voltage difference is imposed between the two electrode plates, the two types of pigment particles would move to opposite ends (top or bottom) in a display cell. Thus one of the colors of the two types of pigment particles would be seen at the viewing side of the display cell.

For all types of the electrophoretic displays, the fluid contained within the individual display cells of the display is undoubtedly one of the most crucial parts of the device. The composition of the fluid determines, to a large extent, the lifetime, contrast ratio, switching rate and bistability of the device.

In an ideal dispersion, the charged pigment particles remain separate and do not agglomerate or stick to each other or to the electrodes, under all operating conditions. However, with the currently available techniques, aggregation of the charged pigment particles inevitably would occur, especially in a two particle fluid system, due to the fact that the charge property of the pigment particles cannot be well-controlled.

### BRIEF DISCUSSION OF THE DRAWINGS

FIG. 1 illustrates how a charged pigment particle of the present invention is prepared.

FIG. 2 shows the zeta potential of charged pigment particle vs. the amount of a silane coupling agent on the particle surface.

### SUMMARY OF THE PRESENT INVENTION

The present invention is directed to a charged pigment particle useful for an electrophoretic fluid. The charged pigment particle comprises a core pigment particle, wherein the surface of the core pigment particle has been reacted with (a) a first coupling agent comprising a charged or chargeable group, and (b) a second coupling agent comprising a polymerizable group capable of forming a polymer layer surrounding the charged pigment particle.

In one embodiment, the core pigment particle is formed from an inorganic pigment. In one embodiment, the inorganic pigment is TiO₂ In one embodiment, the core pigment particle is of a black color and the black particle may be formed from manganese ferrite black spinel or copper chromite black spinel.

In one embodiment, the core pigment particle is formed from an organic pigment.

In one embodiment, the core pigment particle comprising a thin coating of SiO₂, Al₂O₃, ZrO₂ or a combination thereof.

In one embodiment, the surface of the core pigment particle comprises anchoring groups. In one embodiment, the anchoring group is a hydroxyl group.

In one embodiment, the weight of the first coupling agent is about 0.1% to about 10% of the particle.

In one embodiment, the weight of the second coupling agent is about 0.1% to about 6% of the particle.

In one embodiment, the first coupling agent comprises a silane entity.

In one embodiment, the charged or chargeable group is a positively charged entity. In another embodiment, the charged or chargeable group is a negatively charged entity.

In one embodiment, the first coupling agent is aminopropyltriethoxysilane, nonafluorohexyl triethoxysilane, (tridecafluoro-1,1,2,2-tetrahydrooctyl)trimethoxysilance or (tridecafluoro-1,1,2,2-tetrahydrooctyl)trichlorosilane.

In one embodiment, the second coupling agent comprises a polymerizable group which is an acrylate or vinyl group.

In one embodiment, the second coupling agent is methacryloxypropyltrimethoxysilane or N-[3-(trimethoxysilyl)propyl]-N′-(4-vinylbenzyl)ethylenediamine hydrochloride).

In one embodiment, the second coupling agent is 4,4′-azobis(4-cyanovaleic acid) or 2,2′-azobis(2-methylpropionamidine)dihydrochloride.

In one embodiment, the polymer layer is formed from lauryl acrylate, lauryl methacrylate, 2-ethylhexyl acrylate, 2-ethylhexyl methacrylate, hexyl acrylate, hexyl methacrylate, n-octyl acrylate, n-octyl methacrylate, n-octadecyl acrylate, n-octadecyl methacrylate or monomethacryloxypropyl terminated polydimethylsiloxane.

In one embodiment, the polymer layer is a cross-linked polymer network.

In one embodiment, an electrophoretic fluid comprising a charged pigment particle of the present invention, dispersed in a dielectric solvent or solvent mixture. In one embodiment, the fluid comprises two types of charged pigment particle carrying opposite charge polarities and of contrasting colors.

### DETAILED DESCRIPTION OF THE INVENTION

An electrophoretic display relies on the movement of charged pigment particles under an electric field to display images. The solvent or solvent mixture to disperse the charged pigment particles is usually an organic solvent with a low dielectric constant.

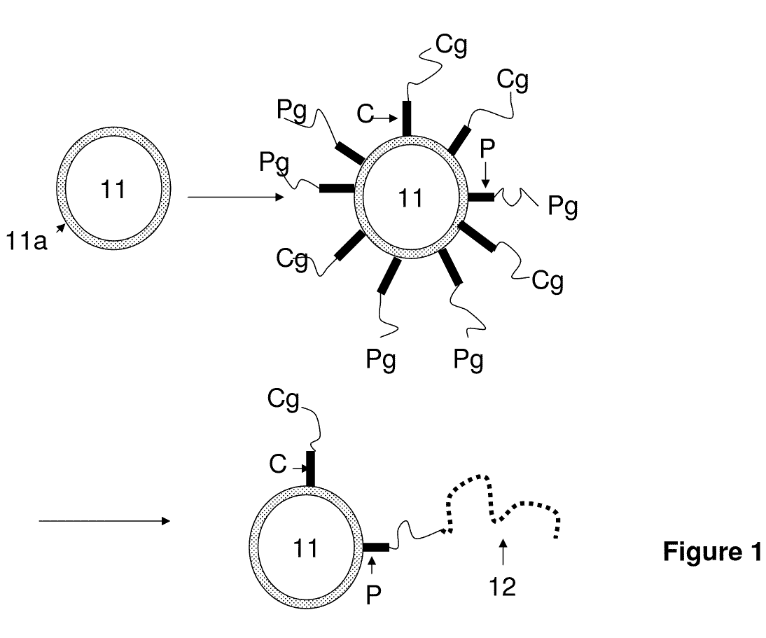

The present inventors have discovered that the charge property of the charged pigment particles can be controlled. FIG. 1 illustrates how such charged pigment particles may be prepared. By adjusting the charge property of the charged pigment particles to a suitable level for an electrophoretic display system, a faster switching speed, a higher contrast ratio and better image bistability may be achieved.

The process starts from core pigment particles (11). The core pigment particles suitable for the present invention may be any types of pigment particles. For example, they may be formed from an inorganic pigment, such as TiO₂, ZrO₂, ZnO, Al₂O₃, Cl pigment black 26 or 28 or the like (e.g., manganese ferrite black spinel or copper chromite black spinel). They also may be formed from an organic pigment such as phthalocyanine blue, phthalocyanine green, diarylide yellow, diarylide AAOT yellow, and quinacridone, azo, rhodamine, perylene pigment series from Sun Chemical, Hansa yellow G particles from Kanto Chemical, and Carbon Lampblack from Fisher.

While it is not always necessary, the core pigment particles preferably are pre-treated to have a thin layer (11a) of coating on the particle surface. The thin coating may be formed of SiO₂, Al₂O₃, ZrO₂ or the like, or any combination thereof. The surface pre-coating preferably is in an amount of at least 5% by weight of the core pigment particles. In one example, the surface coating may have at least 5% by weight of Al₂O₃ and/or at least 7% by weight of SiO₂.

The thin coating has many advantages. For example, it minimizes the photocatalytic effect of the pigment particles (e.g., TiO₂ particles). In addition, the coating increases the surface area of the particles to more than 15 m²/gram, thus providing the possibility of having more anchoring groups on the particle surface.

The specific gravity of the core pigment particles is preferably less than 4. The oil absorption value of the core particles is preferably higher than 25 and the size of the core particles is preferably in the range of about 0.1 um to about 0.6 um.

Anchoring groups (not shown in FIG. 1) are needed on the surface of the core particles in order for the coupling agents C and P to be attached to the particle surface. In one embodiment, the anchoring groups may be hydroxyl groups.

Some of the hydroxyl groups on the particle surface are present on the particle surface as a result of the pre-treating process, as described above. When the coupling agents C and P contain silane, the hydroxyl groups are preferred anchoring groups.

However, the scope of the present invention is not limited to the hydroxyl groups being the anchoring groups. In other words, depending on the coupling agents used, other types of anchoring group may also be suitable. Examples may include, but are not limited to, —COOH, —NH₃ or the diazonium group.

The surface of the core particles is then functionalized by the two types of coupling agent, one of which (C) contains a charged or chargeable group (Cg) and the other (P) contains a polymerizable group (Pg).

In one embodiment, the coupling agents (C) and (P) are pre-mixed and the mixture is then reacted with the anchoring groups on the surface of the core pigment particles. This is referred to as a one step process.

In another embodiment, the reaction of the coupling agent (C) with the anchoring groups on the particle surface and the reaction of the coupling agent (P) with the anchoring groups on the particle surface are carried out sequentially. It is preferred that the coupling agent (C) is added before the coupling agent (P). This is referred to as a two step process.

The two step process is preferred because it is easier to be controlled than the one step process. In addition, the charged or chargeable group (Cg) in the coupling agent (C) will be protected by the outer layer of the coupling agent (P) and a polymer layer formed from polymerization of the coupling agent (P). Good protection of the charged or chargeable group can prevent the resulting two oppositely charged particles from forming aggregation in a dual particle dispersion system.

Particle charge can be controlled by adjusting the actual amount of the coupling agent (C) on the particle surface. The preferred range of the coupling agent (C) on the particle surface may vary from about 0.1% to about 10% by weight of the particle, more preferably about 0.2% to about 4% by weight of the particle. In one example, the coupling agent may be a fluorinated silane which may be used to adjust the negative charge level of the TiO₂ particles.

The preferred range of the coupling agent (P) on the particle surface may vary from about 0.1% to about 6% by weight of the particle, more preferably from about 1% to about 4% by weight of the particle.

If the coupling agents C and P are silane-containing agents, the commonly used organosilanes may be suitable. Such organosilanes may be expressed as follows:

X—Si(R¹)(R²)(R³) (I)

wherein X is an organic substituent and R¹, R² and R³ are independently a hydrolysable group.

In one embodiment, R¹, R² and R³ are independently hydrolysable substituents, such as chloro, methoxy and ethoxy, any other alkoxy groups. The silanes containing the alkoxy groups may be hydrolyzed to form silanol-containing species. These silanol species will react with the anchoring groups on the core particle surface through condensation. The coupling efficiency of silane to the core particle surface depends on the available anchoring groups (i.e., hydroxyl groups) on the particle surface. The type of the silane coupling agent and process conditions, such as reaction time, temperature or chemical concentrations, would also influence the coupling efficiency.

The reaction conditions for the silane coupling reaction would depend on the type of the coupling agent and the type of the core pigment particles used. In any case, a person skilled in the art would know how to choose the proper reaction conditions based on the coupling agent and pigment particles selected.

More specifically, the first type of coupling agent (C) comprises at least one charged or chargeable group (Cg).

In the context of the present invention, the preferred charged or chargeable groups may be (i) a positively charged entity such as an amino group, a metal ion or the like or (ii) a negatively charged entity such as a carboxyl group, a halogen group (e.g., a fluorinated group or chlorinated group), hydroxyl group, sulfonic group, phosphate group, chromate group, borate group, silicate group or the like.

Alternatively, the coupling agent (C) may comprise a group that can undergo a reaction to form a chargeable group, for example, an epoxide that, under acidic conditions, will react to form a chargeable group (Cg).

Examples of such coupling agent (C) may include, but are not limited to, silane coupling agent, which may form a bond with the anchoring group on the particle surface; azo coupling agent, which is the most widely used in the industrial production of dyes, lakes and pigments; or aromatic diazonium ions, which may act as electrophiles in coupling reactions with activated aromatics such as anilines or phenols.

Preferred positively charged group is amino group and examples of useful coupling agent, in this category, may include aminopropyltriethoxysilane.

Preferred negatively charged groups are phosphate group and fluorinated alkyl and examples of useful coupling agent, in this case, may include nonafluorohexyl triethoxysilane, (tridecafluoro-1,1,2,2-tetrahydrooctyl)trimethoxysilance, (tridecafluoro-1,1,2,2-tetrahydrooctyl)trichlorosilane, or any other silane with a halogenated element in the organic substituent (X) in Formula (I).

The second type of coupling agent (P) comprises at least one polymerizable group (Pg); so that a polymer layer may be formed over the surface of the core particles. The second coupling agent (P) is also attached to the particle surface through the chemical bonding between the reactive group on the coupling agent (P) and the anchoring group on the particle surface, or between the reactive group of the coupling agent (P) and the reactive group of the coupling agent (C) to form a network or multiple layers.

The (P) type coupling agent on the particle surface may form silicon oxygen crosslink with the (C) type coupling agent, so that the organic substituent X in the silane of Formula (I) above is available to react with monomers, oligomers or polymers to form a polymer layer (12).

For brevity, FIG. 1 only shows one coupling agent (C) having a charged or chargeable group (Cg) and one coupling agent (P) having a polymer structure (12) formed from a polymerizable group (Pg). In practice, the core pigment particle (11) is surrounded by coupling agents (C) and a polymer layer formed from a plurality of coupling agent (P).

In one embodiment, coupling agent P may contain acrylate or vinyl group for further polymerization. For example, silanes with acrylate group (e.g., methacryloxypropyltrimethoxysilane or N-[3-(trimethoxysilyl)propyl]-N′-(4-vinylbenzyl)ethylenediamine hydrochloride) may be coupled to the core particle surface, and then different types of acrylate monomers may be polymerized onto the particle surface to form the polymer layer.

In another embodiment, coupling agent P may contain radical initiator group which can initiate polymerization to graft polymer onto particle surface. For example, 4,4′-azobis(4-cyanovaleic acid) or 2,2′-azobis(2-methylpropionamidine)dihydrochloride can bond to the particle surface and initiate polymerization.

For a typical two step process, the preparation of the charged pigment particles may be carried out by first dispersing core pigment particles in a suitable solvent, such as alcohol, an alcohol/water mixture or methylethylketone (MEK), which is then followed by adding a silane coupling agent (C) upon sonication, agitation or stirring. Such a reaction is carried out at ambient temperature or at about 40° C. to about 80° C. for about 30 minutes to several hours. The resulting dispersion is centrifuged to separate the pigment particles from the solvent. A small sample, after washing and drying, is usually reserved for testing by TGA to determine the actual amount of silane coupling agent (C) bonded on the particle surface. The remaining sample is then re-dispersed in a solvent and subjected to a second reaction with a silane coupling agent (P). After the second reaction is completed, the resulting dispersion is centrifuged and washed. The final product is dried in a vacuum oven for 16 hours and grinded for the polymerization process to form a polymer layer.

The polymer layer formed from the coupling agent (P) is desired to create a steric barrier of about 1 nm to about 50 nm, preferably about 5 nm to about 30 nm, and more preferably about 10 nm to about 20 nm, in thickness, on the pigment particle surface.

Suitable polymeric layer, in the context of the present invention, may include, but are not limited polyacrylate and polyacrylate with different derivatives, such as siloxane grafted acrylate, fluorinated acrylate, etc. Therefore, suitable monomers for forming the polymer layer may include, but are not limited to, lauryl acrylate, lauryl methacrylate, 2-ethylhexyl acrylate, 2-ethylhexyl methacrylate, hexyl acrylate, hexyl methacrylate, n-octyl acrylate, n-octyl methacrylate, n-octadecyl acrylate, n-octadecyl methacrylate, and monomethacryloxypropyl terminated polydimethylsiloxane.

On the surface of the pigment particles, there may be only one single type of the polymer layer or several types of polymer layer of different structures.

The polymer layer may also be cross-linked to form a polymer network over the surface of the core pigment particles.

Another aspect of the present invention is directed to an electrophoretic fluid comprising pigment particles as described above dispersed in a solvent or solvent mixture. The fluid may comprise only one type of pigment particles or two types of pigment particles of contrast colors and carrying opposite charge polarities. In a two-particle system, at least one type of the particles is prepared according to the present invention.

The solvent or solvent mixture in which the pigment particles are dispersed preferably has a low viscosity and a dielectric constant in the range of about 2 to about 30, preferably about 2 to about 15 for high particle mobility. Examples of suitable dielectric solvent include hydrocarbons such as isopar, decahydronaphthalene (DECALIN), 5-ethylidene-2-norbornene, fatty oils, paraffin oil; silicon fluids; aromatic hydrocarbons such as toluene, xylene, phenylxylylethane, dodecylbenzene and alkylnaphthalene; halogenated solvents such as perfluorodecalin, perfluorotoluene, perfluoroxylene, dichlorobenzotrifluoride, 3,4,5-trichlorobenzotrifluoride, chloropentafluoro-benzene, dichlorononane, pentachlorobenzene; and perfluorinated solvents such as FC-43, FC-70 and FC-5060 from 3M Company, St. Paul Minn., low molecular weight halogen containing polymers such as poly(perfluoropropylene oxide) from TCI America, Portland, Oreg., poly(chlorotrifluoro-ethylene) such as Halocarbon Oils from Halocarbon Product Corp., River Edge, N.J., perfluoropolyalkylether such as Galden from Ausimont or Krytox Oils and Greases K-Fluid Series from DuPont, Delaware, polydimethylsiloxane based silicone oil from Dow-corning (DC-200). The solvent or solvent mixture may be colored by a dye or pigment.

A charge control agent (CCA) may be added to the electrophoretic fluid of the present invention. Useful charge control agents may include, but are not limited to, sodium dodecylbenzenesulfonate, metal soap, polybutene succinimide, maleic anhydride copolymers, vinylpyridine copolymers, vinylpyrrolidone copolymer, (meth)acrylic acid copolymers or N,N-dimethylaminoethyl(meth)acrylate copolymers), Alcolec LV30 (soy lecithin), Petrostep B100 (petroleum sulfonate) or B70 (barium sulfonate), Solsperse 17000 (active polymeric dispersant), Solsperse 9000 (active polymeric dispersant), OLOA 11000 (succinimide ashless dispersant), OLOA 1200 (polyisobutylene succinimides), Unithox 750 (ethoxylates), Petronate L (sodium sulfonate), Disper BYK 101, 2095, 185, 116, 9077 & 220 and ANTI-TERRA series.

In an electrophoretic fluid comprising two types of pigment particles carrying opposite charge polarities and are of contrast colors, the particles preferably have a polymer layer on their surface as described above to prevent them from sticking to each other. The polymeric layer would serve this purpose. Otherwise, in the case of a black/white display device, the reflectance at the white and black states will suffer.

A further aspect of the invention is directed to an electrophoretic display wherein the display cells are filled with an electrophoretic fluid as described above. The term “display cell” is intended to refer to a micro-container which is individually filled with a display fluid. Examples of “display cell” include, but are not limited to, microcups, microcapsules, micro-channels, other partition-typed display cells and equivalents thereof.

### EXAMPLE 1

Experiments were carried out using the procedure as described in this application. The core pigment particles were TiO₂ particles, (tridecafluoro-1,1,2,2-tetrahydrooctyl)trimethoxysilance was used as the coupling agent (C), and 3-(trimethoxysilyl)propyl methacrylate was used as the coupling agent (P). The final particles were dispersed in a dielectric solvent or solvent mixture with surfactants and/or charge controlling agents added. The Zeta potentials of the final particles were measured by ZetaPALS from BROOKHAVEN INSTRUMENTS CORPORATION.

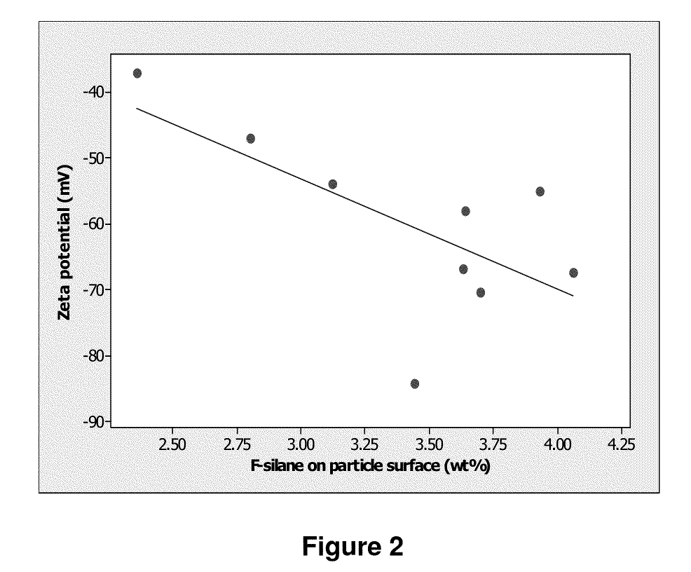

As shown in FIG. 2, the charge level of the pigment particles can be controlled by adjusting the amount of the fluorinated silane, which is the coupling agent (C) on the particle surface. With more fluorinated silane on the particle surface, the pigment particles showed a higher negative charge.

While the present invention has been described with reference to the specific embodiments thereof, it should be understood by those skilled in the art that various changes may be made and equivalents may be substituted without departing from the scope of the invention. In addition, many modifications may be made to adapt a particular situation, materials, compositions, processes, process step or steps, to the objective, spirit and scope of the present invention. All such modifications are intended to be within the scope of the claims appended hereto.

What is claimed is:

1. A charged pigment particle useful for an electrophoretic fluid comprising a core pigment particle, wherein the surface of the core pigment particle has been reacted with (a) a first coupling agent comprising a charged or chargeable group, and (b) a second coupling agent comprising a polymerizable group capable of forming a polymer layer surrounding the charged pigment particle.

2. The particle of claim 1, wherein the core pigment particle is formed from an inorganic pigment.

3. The particle of claim 2, wherein the inorganic pigment is TiO_{2.}

4. The particle of claim 1, wherein the core pigment particle is of a black color.

5. The particle of claim 4, wherein the black particle is formed from manganese ferrite black spinel or copper chromite black spinel.

6. The particle of claim 1, wherein the core pigment particle is formed from an organic pigment.

7. The particle of claim 1, wherein the core pigment particle comprising a thin coating of SiO₂, Al₂O₃, ZrO₂, or a combination thereof.

8. The particle of claim 1, wherein the surface of the core pigment particle comprises anchoring groups to react with the first and the second coupling agents.

9. The particle of claim 8, wherein the anchoring group is a hydroxyl group.

10. The particle of claim 1, wherein the weight of the first coupling agent is about 0.1% to about 10% of the particle.

11. The particle of claim 1, wherein the weight of the second coupling agent is about 0.1% to about 6% of the particle.

12. The particle of claim 1, wherein the first coupling agent comprises a silane entity.

13. The particle of claim 1, wherein the charged or chargeable group is a positively charged entity.

14. The particle of claim 1, wherein the charged or chargeable group is a negatively charged entity.

15. The particle of claim 1, wherein the first coupling agent is aminopropyltriethoxysilane, nonafluorohexyl triethoxysilane, (tridecafluoro-1,1,2,2-tetrahydrooctyl)trimethoxysilance or (tridecafluoro-1,1,2,2-tetrahydrooctyl)trichlorosilane.

16. The particle of claim 1, wherein the second coupling agent comprises a polymerizable group which is an acrylate or vinyl group.

17. The particle of claim 1, wherein the second coupling agent is methacryloxypropyltrimethoxysilane or N-[3-(trimethoxysilyl)propyl]-N′-(4-vinylbenzyl)ethylenediamine hydrochloride).

18. The particle of claim 1, wherein the second coupling agent is 4,4′-azobis(4-cyanovaleic acid) or 2,2′-azobis(2-methylpropionamidine)dihydrochloride.

19. The particle of claim 1, wherein the polymer layer is formed from lauryl acrylate, lauryl methacrylate, 2-ethylhexyl acrylate, 2-ethylhexyl methacrylate, hexyl acrylate, hexyl methacrylate, n-octyl acrylate, n-octyl methacrylate, n-octadecyl acrylate, n-octadecyl methacrylate, or monomethacryloxypropyl terminated polydimethylsiloxane.

20. The particle of claim 1, wherein the polymer layer is a cross-linked polymer network.

21. An electrophoretic fluid comprising a charged pigment particle of claim 1 dispersed in a dielectric solvent or solvent mixture.

22. The fluid of claim 21, which comprises two types of charged pigment particle carrying opposite charge polarities and of contrasting colors.
